(19) United States
(12) Patent Application Publication
(10) Pub. No.: US 2015/0361331 A1
(43) Pub. Date: Dec. 17, 2015

(54) A Proppant

(71) Applicant: BASF SE, Ludwigshafen (DE)

(72) Inventors: Christopher M. Tanguay, Trenton, MI (US); Fikri Emrah Alemdaroglu, Istanbul (TR); Rajesh Kumar, Riverview, MI (US)

(21) Appl. No.: 14/763,851

(22) PCT Filed: Jan. 27, 2014
(86) PCT No.: PCT/US14/13157

§ 371 Date: Jul. 28, 2015

Related U.S. Application Data
(60) Provisional application No. 61/759,776, filed on Feb. 1, 2013.

(51) Int. Cl. C09K 8/80; E21B 43/267; E21B 43/26

(52) U.S. Cl. CPC C09K 8/805; E21B 43/26; E21B 43/267

(57) ABSTRACT

A proppant comprises a particle and a polyoxazolidone isocyanurate coating disposed about the particle. The polyoxazolidone isocyanurate coating comprises the reaction product of a glycidyl epoxy resin and an isocyanate in the presence of a catalyst. A method of forming the proppant comprises the steps of providing the particle, providing the glycidyl epoxy resin, providing the isocyanate, and providing the catalyst. The method also includes the steps of combining the glycidyl epoxy resin and the isocyanate in the presence of the catalyst to react and form the polyoxazolidone isocyanurate coating and coating the particle with the polyoxazolidone isocyanurate coating to form the proppant.

### FIELD OF THE INVENTION

The subject invention generally relates to a proppant and a method of forming the proppant. More specifically, the subject invention relates to a proppant which comprises a particle and a coating disposed on the particle, and which is used during hydraulic fracturing of a subterranean formation.

### DESCRIPTION OF THE RELATED ART

Domestic energy needs in the United States currently outpace readily accessible energy resources, which has forced an increasing dependence on foreign petroleum fuels, such as oil and gas. At the same time, existing United States energy resources are significantly underutilized, in part due to inefficient oil and gas procurement methods and a deterioration in the quality of raw materials such as unrefined petroleum fuels.

Petroleum fuels are typically procured from subsurface reservoirs via a wellbore. Petroleum fuels are currently procured from low-permeability reservoirs through hydraulic fracturing of subterranean formations, such as bodies of rock having varying degrees of porosity and permeability. Hydraulic fracturing enhances production by creating fractures that emanate from the subsurface reservoir or wellbore, and provides increased flow channels for petroleum fuels. During hydraulic fracturing, specially-engineered carrier fluids are pumped at high pressure and velocity into the subsurface reservoir to cause fractures in the subterranean formations. A propping agent, i.e., a proppant, is mixed with the carrier fluids to keep the fractures open when hydraulic fracturing is complete. The proppant typically comprises a particle and a coating disposed on the particle. The proppant remains in place in the fractures once the high pressure is removed, and thereby props open the fractures to enhance petroleum fuel flow into the wellbore. Consequently, the proppant increases procurement of petroleum fuel by creating a high-permeability, supported channel through which the petroleum fuel can flow.

However, many existing proppants exhibit inadequate thermal stability for high temperature and pressure applications, e.g. wellbores and subsurface reservoirs having temperatures greater than 70° F. and pressures, i.e., closure stresses, greater than 7,500 psi. As an example of a high temperature application, certain wellbores and subsurface reservoirs throughout the world have temperatures of about 375° F. and 540° F. As an example of a high pressure application, certain wellbores and subsurface reservoirs throughout the world have closure stresses that exceed 12,000 or even 14,000 psi. As such, many existing proppants, which comprise coatings, have coatings such as epoxy or phenolic coatings, which melt, degrade, and/or shear off the particle in an uncontrolled manner when exposed to such high temperatures and pressures. Also, many existing proppants do not include active agents, such as microorganisms and catalysts, to improve the quality of the petroleum fuel recovered from the subsurface reservoir.

Further, many existing proppants comprise coatings having inadequate crush resistance. That is, many existing proppants comprise non-uniform coatings that include defects, such as gaps or indentations, which contribute to premature breakdown and/or failure of the coating. Since the coating typically provides a cushioning effect for the proppant and evenly distributes high pressures around the proppant, premature breakdown and/or failure of the coating undermines the crush resistance of the proppant. Crushed proppants cannot effectively prop open fractures and often contribute to impurities in unrefined petroleum fuels in the form of dust particles.

Moreover, many existing proppants also exhibit unpredictable consolidation patterns and suffer from inadequate permeability in wellbores, i.e., the extent to which the proppant allows the flow of petroleum fuels. That is, many existing proppants have a lower permeability and impede petroleum fuel flow. Further, many existing proppants consolidate into aggregated, near-solid, non-permeable proppant packs and prevent adequate flow and procurement of petroleum fuels from subsurface reservoirs.

Also, many existing proppants are not compatible with low-viscosity carrier fluids having viscosities of less than about 3,000 cps at 80° C. Low-viscosity carrier fluids are typically pumped into wellbores at higher pressures than high-viscosity carrier fluids to ensure proper fracturing of the subterranean formation. Consequently, many existing coatings fail mechanically, i.e., shear off the particle, when exposed to high pressures or react chemically with low-viscosity carrier fluids and degrade.

Finally, many existing proppants are coated via noneconomical coating processes and therefore contribute to increased production costs. That is, many existing proppants require multiple layers of coatings, which results in time-consuming and expensive coating processes.

Due to the inadequacies of existing proppants, there remains an opportunity to provide an improved proppant.

### SUMMARY OF THE INVENTION AND ADVANTAGES

The subject invention provides a proppant for hydraulically fracturing a subterranean formation. The proppant comprises a particle and a polyoxazolidone isocyanurate coating disposed about the particle. The polyoxazolidone isocyanurate coating comprises the reaction product of a glycidyl epoxy resin and an isocyanate, in the presence of a catalyst.

A method of forming the proppant comprises the steps of providing the particle, providing the glycidyl epoxy resin, providing the isocyanate, and providing the catalyst. The method also includes the steps of combining the glycidyl epoxy resin and the isocyanate in the presence of the catalyst to react and form the polyoxazolidone isocyanurate coating and coating the particle with the polyoxazolidone isocyanurate coating to form the proppant.

Advantageously, the proppant of the subject invention improves upon the performance of existing proppants. The performance of the proppant is attributable to the polyoxazolidone isocyanurate coating. In addition, the proppant of the subject invention is formed efficiently, requiring few resources.

### DETAILED DESCRIPTION OF THE INVENTION

The subject invention includes a proppant, a method of forming, or preparing, the proppant, a method of hydraulically fracturing a subterranean formation, and a method of filtering a fluid. The proppant may be used, in conjunction with a carrier fluid, to hydraulically fracture the subterranean formation which defines a subsurface reservoir (e.g. a wellbore or reservoir itself). Here, the proppant props open the fractures in the subterranean formation after the hydraulic fracturing. In one embodiment, the proppant may also be used to filter unrefined petroleum fuels, e.g. crude oil, in fractures to improve feedstock quality for refineries. However, it is to be appreciated that the proppant of the subject invention can also have applications beyond hydraulic fracturing and crude oil filtration, including, but not limited to, water filtration and artificial turf.

The proppant comprises a particle and a polyoxazolidone isocyanurate coating disposed on the particle. As used herein, the terminology “disposed on” encompasses the polyoxazolidone isocyanurate coating being disposed about the particle and also encompasses both partial and complete covering of the particle by the polyoxazolidone isocyanurate coating. The polyoxazolidone isocyanurate coating is disposed on the particle to an extent sufficient to change the properties of the particle, e.g., to form a particle having a polyoxazolidone isocyanurate coating thereon which can be effectively used as a proppant. As such, any given sample of the proppant typically includes particles having the polyoxazolidone isocyanurate coating disposed thereon, and the polyoxazolidone isocyanurate coating is typically disposed on a large enough surface area of each individual particle so that the sample of the proppant can effectively prop open fractures in the subterranean formation during and after the hydraulic fracturing, filter crude oil, etc. The polyoxazolidone isocyanurate coatings described additionally below.

Although the particle may be of any size, the particle may have a particle size distribution of from 10 to 140 mesh, alternatively from 20 to 70 mesh, as measured in accordance with standard sizing techniques using the United States Sieve Series. That is, the particle may have a particle size of from 105 to 2,000, alternatively from 210 to 841, μm. Particles having such particle sizes allow less polyoxazolidone isocyanurate coating to be used, allow the polyoxazolidone isocyanurate coating to be applied to the particle at a lower viscosity, and allow the polyoxazolidone isocyanurate coating to be disposed on the particle with increased uniformity and completeness as compared to particles having other particle sizes.

Although the shape of the particle is not critical, particles having a spherical shape typically impart a smaller increase in viscosity to a hydraulic fracturing composition than particles having other shapes, as set forth in more detail below. The hydraulic fracturing composition is a mixture comprising the carrier fluid and the proppant. Typically, the particle is either round or roughly spherical.

The particle typically contains less than 1 part by weight of moisture, based on 100 parts by weight of the particle. Particles containing higher than 1 part by weight of moisture may interfere with sizing techniques and coating the particle (disposing the polyoxazolidone isocyanurate coating about the particle), lead to side-reactions during coating of the particle, and prevent uniform coating of the particle.

Suitable particles for purposes of the subject invention include any known particle for use during hydraulic fracturing, water filtration, or artificial turf preparation. Non-limiting examples of suitable particles include minerals, ceramics such as sintered ceramic particles, sands, nut shells, gravels, mine tailings, coal ashes, rocks (such as bauxite), smelter slag, diatomaceous earth, crushed charcoals, micas, sawdust, wood chips, resinous particles, polymeric particles, and combinations thereof. It is to be appreciated that other particles not recited herein may also be suitable for the purposes of the subject invention.

Sand is a preferred particle and when applied in this technology is typically referred to as frac, or fracturing, sand. Examples of suitable sands include, but are not limited to, Arizona sand, Badger sand, Brady sand, Northern White sand, and Ottawa sand. Based on cost and availability, inorganic materials such as sand and sintered ceramic particles are typically favored for applications not requiring filtration.

A specific example of a sand that is suitable as a particle for the purposes of the subject invention is Arizona sand, a natural grain that is derived from weathering and erosion of preexisting rocks. As such, this sand is typically coarse and is roughly spherical. Another specific example of a sand that is suitable as a particle for the purposes of this invention is Ottawa sand, commercially available from U.S. Silica Company of Berkeley Springs, W. Va. Yet another specific example of a sand that is suitable as a particle for the purposes of this invention is Wisconsin sand, commercially available from Badger Mining Corporation of Berlin, Wis. Particularly preferred sands for application in this invention are Ottawa and Wisconsin sands. Ottawa and Wisconsin sands of various sizes, such as 30/50, 20/40, 40/70, and 70/140 can be used.

Specific examples of suitable sintered ceramic particles include, but are not limited to, aluminum oxide, silica, bauxite, and combinations thereof. The sintered ceramic particle may also include clay-like binders.

An active agent may also be included in the particle. In this context, suitable active agents include, but are not limited to, organic compounds, microorganisms, and catalysts. Specific examples of microorganisms include, but are not limited to, anaerobic microorganisms, aerobic microorganisms, and combinations thereof. A suitable microorganism for the purposes of the subject invention is commercially available from LUCA Technologies of Golden, Colo. Specific examples of suitable catalysts include fluid catalytic cracking catalysts, hydroprocessing catalysts, and combinations thereof. Fluid catalytic cracking catalysts are typically selected for applications requiring petroleum gas and/or gasoline production from crude oil. Hydroprocessing catalysts are typically selected for applications requiring gasoline and/or kerosene production from crude oil. It is also to be appreciated that other catalysts, organic or inorganic, not recited herein may also be suitable for the purposes of the subject invention.

Such additional active agents are typically favored for applications requiring filtration. As one example, sands and sintered ceramic particles are typically useful as a particle for support and propping open fractures in the subterranean formation which defines the subsurface reservoir, and, as an active agent, microorganisms and catalysts are typically useful for removing impurities from crude oil or water. Therefore, a combination of sands/sintered ceramic particles and microorganisms/catalysts as active agents are particularly preferred for crude oil or water filtration.

Suitable particles for purposes of the present invention may even be formed from resins and polymers. Specific examples of resins and polymers for the particle include, but are not limited to, polyurethanes, polycarbodiimides, polyureas, acrylics, polyvinylpyrrolidones, acrrylonitrile-butadiene styrenes, polystyrenes, polyvinyl chlorides, fluoroplastics, polysulfides, nylon, polyamide imides, and combinations thereof.

As indicated above, the proppant includes the polyoxazolidone isocyanurate coating disposed on the particle. The polyoxazolidone isocyanurate coating is selected based on the desired properties and expected operating conditions of the proppant. The polyoxazolidone isocyanurate coating may provide the particle with protection from operating temperatures and pressures in the subterranean formation and/or subsurface reservoir. Further, the polyoxazolidone isocyanurate coating may protect the particle against closure stresses exerted by the subterranean formation. The polyoxazolidone isocyanurate coating may also protect the particle from ambient conditions and minimizes disintegration and/or dusting of the particle. In some embodiments, the polyoxazolidone isocyanurate coating may also provide the proppant with desired chemical reactivity and/or filtration capability.

The polyoxazolidone isocyanurate coating comprises the reaction product of a glycidyl epoxy resin and an isocyanate in the presence of a catalyst. The polyoxazolidone isocyanurate coatings formulated such that the physical properties of the polyoxazolidone isocyanurate coating, such as hardness, strength, toughness, creep, and brittleness are optimized.

Accordingly, the glycidyl epoxy resin may be selected such that the physical properties of the polyoxazolidone isocyanurate coating, such as hardness, strength, toughness, creep, and brittleness are optimized. The glycidyl epoxy resin may be a glycidyl ether epoxy resin, a glycidyl ester epoxy resin, or a glycidyl amine epoxy resin. Of course, the polyoxazolidone isocyanurate coating may be formed with more than one type of glycidyl epoxy resin.

In a preferred embodiment, the glycidyl epoxy resin is a glycidyl ether epoxy resin. A preferred glycidyl ether epoxy is bisphenol-A diglycidyl ether (BADGE), which is also known to those skilled in the art as diglycidyl ether of bisphenol-A (DGEBA). BADGE has the following structure:

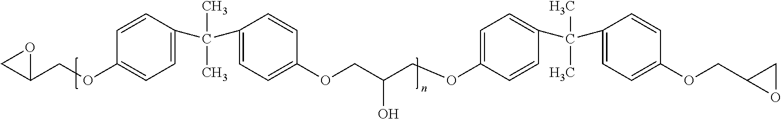

In this embodiment, n may be a number of from 0 to 10, alternatively from 0 to 7, alternatively from 0 to 4. Said differently, the BADGE may have a number average molecular weight of greater than 340, alternatively from 340 to 10,000, alternatively from 340 to 5,000, g/mol.

Bisphenol A and epichlorohydrin are typically reacted to form BADGE. The reaction between bisphenol A and epichlorohydrin can be controlled to produce different molecular weights. Low molecular weight molecules tend to be liquids and higher molecular weight molecules tend to be more viscous liquids or solids. In a preferred embodiment, the BADGE is a low molecular weight liquid.

The glycidyl epoxy resin may be reacted, to form the polyoxazolidone isocyanurate coating, in an amount of from 0.1 to 8, alternatively from 0.5 to 6, alternatively from 1 to 4, alternatively from 1 to 2.5, parts by weight based on 100 parts by weight of the proppant. The amount of glycidyl epoxy resin which is reacted to form the polyoxazolidone isocyanurate coating may vary outside of the ranges above, but is typically both whole and fractional values within these ranges. Further, it is to be appreciated that more than one glycidyl epoxy resin may be reacted to form the polyoxazolidone isocyanurate coating, in which case the total amount of all glycidyl epoxy resins reacted is within the above ranges.

The glycidyl epoxy resin is reacted with an isocyanate. The isocyanate may be selected such that physical properties of the polyoxazolidone isocyanurate coating, such as hardness, strength, toughness, creep, and brittleness are optimized. The isocyanate may be a polyisocyanate having two or more functional groups, e.g. two or more NCO functional groups. Suitable isocyanates for purposes of the present invention include, but are not limited to, aliphatic and aromatic isocyanates. In various embodiments, the isocyanate is selected from the group of diphenylmethane diisocyanates (MDIs), polymeric diphenylmethane diisocyanates (pMDIs), toluene diisocyanates (TDIs), hexamethylene diisocyanates (HDIs), isophorone diisocyanates (IPDIs), and combinations thereof.

The isocyanate may be an isocyanate prepolymer. The isocyanate prepolymer may be a reaction product of an isocyanate and a polyol and/or a polyamine. The isocyanate used in the prepolymer can be any isocyanate as described above. The polyol used to form the prepolymer may be selected from the group of ethylene glycol, diethylene glycol, propylene glycol, dipropylene glycol, butane diol, glycerol, trimethylolpropane, triethanolamine, pentaerythritol, sorbitol, biopolyols, and combinations thereof. The polyamine used to form the prepolymer may be selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof.

Specific isocyanates that may be used to prepare the polyoxazolidone isocyanurate coating include, but are not limited to, toluene diisocyanate; 4,4′-diphenylmethane diisocyanate; m-phenylene diisocyanate; 1,5-naphthalene diisocyanate; 4-chloro-1; 3-phenylene diisocyanate; tetramethylene diisocyanate; hexamethylene diisocyanate; 1,4-dicyclohexyl diisocyanate; 1,4-cyclohexyl diisocyanate, 2,4,6-toluylene triisocyanate, 1,3-diisopropylphenylene-2,4-dissocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate and 1,3,5-triisopropyl benzene-2,4,6-triisocyanate. Other suitable polyoxazolidone isocyanurate coatings can also be prepared from aromatic diisocyanates or isocyanates having one or two aryl, alkyl, arakyl or alkoxy substituents wherein at least one of these substituents has at least two carbon atoms. Specific examples of suitable isocyanates include LUPRANATE®L5120, LUPRANATE® M, LUPRANATE® ME, LUPRANATE® MI, LUPRANATE® M205, and LUPRANATE® M70, all commercially available from BASF Corporation of Florham Park, N.J.

In one embodiment, the isocyanate is a polymeric isocyanate, such as LUPRANATE® M205. LUPRANATE® M205 comprises polymeric diphenylmethane diisocyanate and has an NCO content of 31.5 weight percent.

The isocyanate may be reacted, to form the polyoxazolidone isocyanurate coating, in an amount of from 0.3 to 17, alternatively from 0.5 to 5 alternatively from 0.7 to 3.5, parts by weight based on 100 parts by weight of the proppant. The amount of isocyanate which is reacted to form the polyoxazolidone isocyanurate coating may vary outside of the ranges above, but is typically both whole and fractional values within these ranges. Further, it is to be appreciated that more than one isocyanate may be reacted to form the polyoxazolidone isocyanurate coating, in which case the total amount of all isocyanates reacted is within the above ranges.

Variations in the amount of the isocyanate and the amount of the glycidyl epoxy resin which are chemically reacted impact the structure of the polyoxazolidone isocyanurate coating. More specifically, an isocyanate to glycidyl epoxy resin ratio impacts the cross linking density of the polyoxazolidone isocyanurate coating. Higher ratios of isocyanate to glycidyl epoxy resin typically yield polyoxazolidone isocyanurate coatings with higher crosslink densities (higher isocyanurate content). Lower ratios of isocyanate to the glycidyl epoxy resin typically yield polyoxazolidone isocyanurate coatings with lower crosslink densities. Said differently, the greater the amount of isocyanate relative to the amount of the glycidyl epoxy resin, the more cross linked the polyoxazolidone isocyanurate coating.

Notably, the T_{g} and the physical properties of the polyoxazolidone isocyanurate coating are directly related to its crosslink density. For example, the higher the crosslink density, the higher the T_{g}. As such, the physical properties of proppants comprising polyoxazolidone isocyanurate coatings can be optimized for effectiveness and use specific to certain subterranean formations/subsurface reservoirs. That is, the polyoxazolidone isocyanurate coatings can be specifically tailored for hydraulically fracturing subterranean formations within specific subsurface reservoirs which have particular temperatures and pressures by adjusting the isocyanate to glycidyl epoxy resin ratio. The polyoxazolidone isocyanurate coating may have a T_{g} of greater than 180, alternatively greater than 200, alternatively greater than 220, ° C.

The ratio, by weight, of the isocyanate to glycidyl epoxy resin which is chemically reacted to form the polyoxazolidone isocyanurate coating may be from 1:6 to 6:1, alternatively from 1:4 to 5:1, alternatively from 1:2 to 4:1.

The glycidyl epoxy resin is reacted with the isocyanate in the presence of the catalyst to form the polyoxazolidone isocyanurate coating. The catalyst may include any suitable catalyst or mixtures of catalysts known in the art which catalyze the formation of polymers comprising oxazolidone and isocyanurate units. Generally, the catalyst is selected from the group of amine catalysts, phosphorous compounds (e.g. phosphines), basic metal compounds, carboxylic acid metal salts, non-basic organo-metallic compounds, and combinations thereof. The catalyst may be present in an amount of from 0.1 to 10, alternatively from 0.15 to 5, alternatively from 0.15 to 3, alternatively from 0.2 to 3, alternatively from 0.2 to 2, parts by weight, parts by weight, based on 100 parts by weight of all the components reacted to form the polyoxazolidone isocyanurate coating. The amount of catalyst present may vary outside of the ranges above, but is typically both whole and fractional values within these ranges. Further, it is to be appreciated that more than one catalyst may be present, in which case the total amount of all catalysts reacted is within the above ranges.

For example, the glycidyl epoxy resin may be reacted with the isocyanate in the presence of an amine catalyst, e.g., a tertiary amine catalyst, to form the polyoxazolidone isocyanurate coating. Suitable examples of the amine catalyst include, but are not limited to: N,N-dimethylcyclohexylamine (DMCHA); N-methylimidazole/1-methylimidazole (1-MEI); 4-Methylimidazole (4-MEI); 2-ethyl-4-methylimidazole (EMI); triethylenediamine (TEDA, DABCO); 33% triethylenediamine solution in dipropylene glycol (33% TEDA in DPG); 1,8-Diazabicyclo-5,4,0-undecen-7 (DBU); N,N-bis[3-(dimethylamino)propyl]-N′,N′-dimethylpropane-1,3-diamine; N,N,N-tris-(3-Dimethyl aminopropyl)amine; N,N-Dimethylbenzylamine (BDMA); 2-((2-(dimethylamino)ethyl)methylamino)-ethanol; N-Methylmorpholine (NMM); N,N,N′,N′-Tetramethylethylenediamine (TMEDA); 3-[2-(dimethylamino)ethoxy]-N,N-dimethylpropylamine; N-ethylmorpholine (MEM); N,N′,N″,N″-Pentamethyldiethylenetriamine (PMDETA); Tetramethyl-1,3-diaminopropane; 1,4-Dimethyl-piperazine (DMP); Dimethylformamide (DMF); 1,3,5-Tris[3-(dimethylamino)propyl]hexahydro-1,3,5-triazine; 1,1′-{[3-(Dimethylamino)propyl]imino}bis-2-propanol (DPA); 2,2-Dimorpholinodiethylether (DMDEE); N,N,N′,N′-tetramethyldipropylenetriamine; N,N,N′,N″,N″-Pentamethyldipropylenetriamine; 1-[Bis[3-(dimethylamino)propyl]amino]-2-propanol; Dimethyaminoethoxyethanol; N,N,N′,N′-Tetramethyl-1,6-hexanediamine (TMHD); and N,N-bis[3-(dimethylamino)propyl]-N′,N′-dimethylpropane-1,3-diamine.

The amine catalyst may be an azole catalyst. An azole is a class of five-membered nitrogen heterocyclic ring compounds containing at least one other non-carbon atom of nitrogen, sulfur, or oxygen. Suitable examples of the azole catalyst include, but are not limited to, pyrroles, pyrazoles, imidazoles, triazoles, tetrazoles, pentazoles, oxazoles, isoxazole, thiazole, and isothiazoles.

The azole catalyst may include two or more nitrogen atoms. Suitable examples of azole catalysts which include two or more nitrogen atoms include, but are not limited to, pyrazoles, imidazoles, triazoles, tetrazoles, and pentazoles. Preferably, the azole catalyst is an imidazole catalyst.

In one suitable, non-limiting example, the imidazole catalyst is N-methylimidazole(1-methylimidazole), which has the following structure:

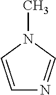

If present, the N-methylimidazole may be present in an amount of from 0.1 to 10, alternatively from 0.15 to 5, alternatively from 0.15 to 3, alternatively from 0.2 to 3, alternatively from 0.2 to 2, parts by weight, based on 100 parts by weight of all the components reacted to form the polyoxazolidone isocyanurate coating.

In another suitable non-limiting example, the imidazole catalyst is 2-ethyl-4-methylimidazole (EMI), which has the following structure:

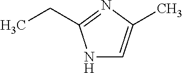

If present, the EMI may be present in an amount of from 0.1 to 10, alternatively from 0.15 to 5, alternatively from 0.15 to 3, alternatively from 0.2 to 3, alternatively from 0.2 to 2, parts by weight, parts by weight, based on 100 parts by weight of all the components reacted to form the polyoxazolidone isocyanurate coating.

However, the amine catalyst is not limited to azoles or imidazoles. In one such suitable non-limiting example, the amine catalyst is 1,8-Diazabicyclo-5,4,0-undecen-7 (DBU), which has the following structure:

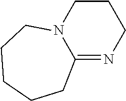 [SMILES: C1CCC2=NCCCN2CC1]

If present, the DBU may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

In another suitable non-limiting example, the amine catalyst is Diazabicyclo[2,2,2]-octane (TEDA, DABCO), which has the following structure:

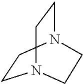

If present, the TEDA may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

In yet another suitable non-limiting example, the amine catalyst is N,N-dimethylcyclohexylamine (DMCHA), which has the following structure:

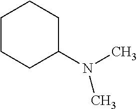

If present, the DMCHA may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

In still another suitable non-limiting example, the amine catalyst is N,N-bis[3-(dimethylamino)propyl]-N′,N′-dimethylpropane-1,3-diamine, which has the following structure:

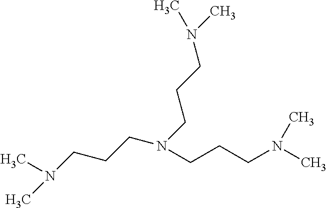

If present, the N,N-bis[3-(dimethylamino)propyl]-N′,N′-dimethylpropane-1,3-diamine may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

Specific, non-limiting, examples of suitable amine catalysts include 1-methylimidazole and 2-ethyl-4-methylimidazole, LUPRAGEN® N201 which are commercially available from BASF Corporation of BASF Corporation of Florham Park, N.J.; DABCO and DABCO TMR®-4, POLYCAT® DBU Catalyst, N,N-Dimethylcyclohexylamine (DMCHA), and POLYCAT® 9, which are commercially available from Air Products of Allentown, Pa.; and NIAX® Catalyst C77 which is commercially available from Momentive Performance Materials of Albany, N.Y.

The glycidyl epoxy resin may also be reacted with the isocyanate in the presence of a phosphorous compound, e.g., a phosphine catalyst, to form the polyoxazolidone isocyanurate coating. Suitable examples of the phosphine catalyst include, but are not limited to, triphenylphosphine, triethylphosphine, and triethylphosphine oxide. In one embodiment the amine catalyst and the phosphine catalyst are use to catalyze the reaction between the glycidyl epoxy resin and the isocyanate.

In one suitable, non-limiting example, the phosphine catalyst is triphenylphosphine, which has the following structure:

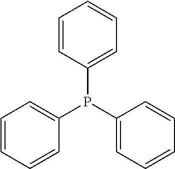 [SMILES: c1ccc(P(c2ccccc2)c2ccccc2)cc1]

If present, the triphenylphosphine may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

In another suitable, non-limiting example, the phosphine catalyst is triethylphosphine, which has the following structure:

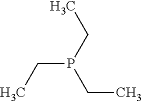

If present, the triethylphosphine may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

In yet another suitable, non-limiting example, the phosphine catalyst is triethylphosphine oxide, which has the following structure:

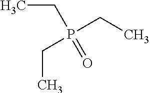

If present, the triethylphosphine oxide may be present in an amount of from 0.1 to 10, alternatively from 0.15 to 5, alternatively from 0.15 to 3, alternatively from 0.2 to 3, alternatively from 0.2 to 2, parts by weight, parts by weight based on 100 parts by weight of all the components reacted to form the polyoxazolidone isocyanurate coating.

The catalysts described above catalyze various chemical reactions involving the glycidyl epoxy resin and the isocyanate. When the glycidyl epoxy resin and the isocyanate are reacted in the presence of the catalysts described above, a number of chemical reactions may take place which form polymers comprising epoxy, oxazolidone, and isocyanurate units or mers. For example, a trimerization of the isocyanate (RNCO) may occur to form isocyanurate units or mers generally represented by the following structure:

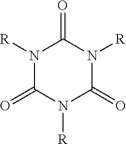

or oxazolidone units or mers may be formed which are generally represented by the following structure:

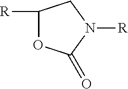

or epoxy units or mers may be formed which are generally represented by the following structure:

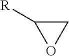

Of course, variations in catalyst type and process parameters (particularly temperature) impact the chemical reactions/reaction pathways and the structure of the polyoxazolidone isocyanurate coating. Without being bound by theory, it is believed that the catalysts described above facilitate the chemical reaction of the glycidyl epoxy resin and the isocyanate to yield a polymer which has oxazolidone and isocyanurate units (the polyoxazolidone isocyanurate coating). The chemical reactions and an resulting polyoxazolidone isocyanurate polymer network are generally represented in the non-limiting, exemplary schematic below:

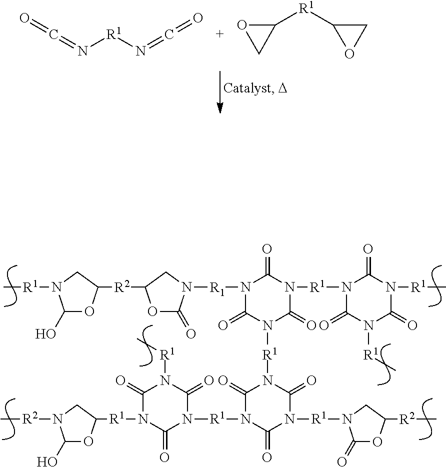

Wherein R¹ and R² can be aromatic and/or aliphatic. In one embodiment, R¹ and R² are aromatic.

As is also described above, variations in catalyst type and process parameters (particularly temperature) impact the structure of the polyoxazolidone isocyanurate coating. Of course, the type of catalyst selected and amount of catalyst used impacts a temperature at which glycidyl epoxy resin and the isocyanate react to form the polyoxazolidone isocyanurate coating as well as the open time of a mixture comprising the glycidyl epoxy resin, the isocyanate, and the catalyst. For example, if the catalyst used to form the polyoxazolidone isocyanurate coating is DMF, the open time may be less than 2 seconds. As another example, if the catalyst used form the polyoxazolidone isocyanurate coating is TEDA, the open time may be 320 seconds.

To illustrate the impact of temperature, if DBU is the catalyst and the reaction temperature is 25° C., the open time may be infinite, i.e., the glycidyl epoxy resin and the isocyanate do not react. The reaction simply does not does not go. However, if DBU is the catalyst and the reaction temperature is 80° C. the open time may be about one hour.

Generally, when an amine catalyst is used to form the polyoxazolidone isocyanurate coating, higher reaction temperatures tend to yield polyoxazolidone isocyanurate comprising a greater percentage of oxazolidone units and lower temperatures tend to yield polyoxazolidone isocyanurate comprising a greater percentage of isocyanurate units.

The polyoxazolidone isocyanurate coating may comprise greater than 10, alternatively greater than 20, alternatively greater than 30, % oxazolidone units. Furthermore, the polyoxazolidone isocyanurate coating may comprise greater than 40, % isocyanurate units. In one embodiment the polyoxazolidone isocyanurate coating comprises about 20% oxazolidone units and about 80% isocyanurate units. In another embodiment, the polyoxazolidone isocyanurate coating comprises about 50% oxazolidone units and about 50% isocyanurate units. In yet another embodiment, the polyoxazolidone isocyanurate coating comprises about 80% oxazolidone units and about 20% isocyanurate units. Of course, the total percentage of oxazolidone and isocyanurate units in the polyoxazolidone isocyanurate coating does not always add up to 100% because there are other units or mers which result from the reaction of the glycidyl epoxy resin and the isocyanate such as various epoxies, imides, and acid units or mers.

Accordingly, variations in the catalyst type and the process parameters (particularly reaction temperature) as well as the amounts of the glycidyl epoxy resin and the isocyanate reacted impact the chemical reactions/reaction pathways and the structure of the polyoxazolidone isocyanurate coating. As such, the physical properties of proppants comprising polyoxazolidone isocyanurate coatings can be optimized for effectiveness and use specific to certain subterranean formations/subsurface reservoirs. That is, the coatings can be specifically tailored for hydraulically fracturing subterranean formations within specific subsurface reservoirs which have particular temperatures and pressures.

The polyoxazolidone isocyanurate coating may further include additives. Suitable additives include, but are not limited to, surfactants, blowing agents, wetting agents, blocking agents, dyes, pigments, diluents, solvents, specialized functional additives such as antioxidants, ultraviolet stabilizers, biocides, adhesion promoters, antistatic agents, fire retardants, fragrances, and combinations of the group. For example, a pigment allows the polyoxazolidone isocyanurate coating to be visually evaluated for thickness and integrity and can provide various marketing advantages. Also, physical blowing agents and chemical blowing agents are typically selected for polyoxazolidone isocyanurate coatings requiring foaming. That is, in one embodiment, the coating may comprise a foam coating disposed on the particle. Again, it is to be understood that the terminology “disposed on” encompasses both partial and complete covering of the particle by the polyoxazolidone isocyanurate coating, a foam coating in this instance. The foam coating may be useful for applications requiring enhanced contact between the proppant and crude oil. That is, the foam coating typically defines microchannels and increases a surface area for contact between crude oil and the catalyst and/or microorganism.

The polyoxazolidone isocyanurate coating may be selected for applications requiring excellent coating stability and adhesion to the particle. Further, polyoxazolidone isocyanurate coating may be selected based on the desired properties and expected operating conditions of a particular application. The polyoxazolidone isocyanurate coating is chemically and physically stable over a range of temperatures and does not typically melt, degrade, and/or shear off the particle in an uncontrolled manner when exposed to higher pressures and temperatures, e.g. pressures and temperatures greater than pressures and temperatures typically found on the earth's surface. As one example, the polyoxazolidone isocyanurate coating is particularly applicable when the proppant is exposed to significant pressure, compression and/or shear forces, and temperatures exceeding 200° C. in the subterranean formation and/or subsurface reservoir defined by the formation. The polyoxazolidone isocyanurate coating is generally viscous to solid nature, and depending on molecular weight. Any suitable polyoxazolidone isocyanurate coating may be used for the purposes of the subject invention.

The polyoxazolidone isocyanurate coating may be present in the proppant in an amount of from 0.5 to 30, alternatively from 0.7 to 10, alternatively from 1 to 5, parts by weight based on 100 parts by weight of the particle. The amount of polyoxazolidone isocyanurate coating present in the proppant may vary outside of the ranges above, but is typically both whole and fractional values within these ranges.

Alternatively, the polyoxazolidone isocyanurate coating is typically present in the proppant in an amount of from 0.5 to 30, alternatively from 0.7 to 10, alternatively from 1 to 7, alternatively from 1 to 5, alternatively 1 to 4, alternatively 2 to 4, parts by weight based on 100 parts by weight of the proppant. The amount of the polyoxazolidone isocyanurate coating present in the proppant may vary outside of the ranges above, but is typically both whole and fractional values within these ranges.

Accordingly, the particle is typically present in the proppant in an amount of from 70 to 99.5, alternatively from 90 to 99.3, alternatively from 93 to 99, alternatively from 95 to 99, alternatively from 96 to 99, alternatively from 96 to 98, parts by weight based on 100 parts by weight of the proppant. The amount of the particle present in the proppant may vary outside of the ranges above, but is typically both whole and fractional values within these ranges.

The polyoxazolidone isocyanurate coating may be formed in-situ where the polyoxazolidone isocyanurate coating is disposed on the particle during formation of the polyoxazolidone isocyanurate coating. Typically the components of the polyoxazolidone isocyanurate coating are combined with the particle and the polyoxazolidone isocyanurate coating is disposed on the particle.

However, in one embodiment a polyoxazolidone isocyanurate coating is formed and some time later applied to, e.g. mixed with, the particle and exposed to temperatures exceeding 100° C. to coat the particle and form the proppant. Advantageously, this embodiment allows the polyoxazolidone isocyanurate coating to be formed at a location designed to handle chemicals, under the control of personnel experienced in handling chemicals. Once formed, the polyoxazolidone isocyanurate coating can be transported to another location, applied to the particle, and heated. There are numerous logistical and practical advantages associated with this embodiment. For example, if the polyoxazolidone isocyanurate coating is being applied to the particle, e.g. frac sand, the polyoxazolidone isocyanurate coating may be applied immediately following the manufacturing of the frac sand, when the frac sand is already at elevated temperature, eliminating the need to reheat the polyoxazolidone isocyanurate coating and the frac sand, thereby reducing the amount of energy required to form the proppant.

In another embodiment, the glycidyl epoxy resin, the isocyanate are reacted in the presence of the catalyst to form the polyoxazolidone isocyanurate coating in a solution. The solution comprises a solvent such as acetone, methylethylketone, and/or methylenechloride. The solution viscosity is controlled by stoichiometry, monofunctional reagents, and a polymer solids level. After the polyoxazolidone isocyanurate coating is formed in the solution, the solution is applied to the particle. The solvent evaporates leaving the polyoxazolidone isocyanurate coating disposed on the particle. Once the polyoxazolidone isocyanurate coating is disposed on the particle to form the proppant, the proppant can be heated to further crosslink the polyoxazolidone isocyanurate coating. Generally, the crosslinking, which occurs as a result of the heating, optimizes physical properties of the polyoxazolidone isocyanurate coating.

In yet another embodiment, the polyoxazolidone isocyanurate coating may also be further defined as controlled-release. That is, the polyoxazolidone isocyanurate coating may systematically dissolve, hydrolyze in a controlled manner, or physically expose the particle to the petroleum fuels in the subsurface reservoir. In one such embodiment, the polyoxazolidone isocyanurate coating typically gradually dissolves in a consistent manner over a pre-determined time period to decrease the thickness of the polyoxazolidone isocyanurate coating. This embodiment is especially useful for applications utilizing the active agent such as the microorganism and/or the catalyst. That is, the polyoxazolidone isocyanurate coating may be controlled-release for applications requiring filtration of petroleum fuels or water.

The polyoxazolidone isocyanurate coating may exhibit excellent non-wettability in the presence of water, as measured in accordance with standard contact angle measurement methods known in the art. The polyoxazolidone isocyanurate coating may have a contact angle of greater than 90° and may be categorized as hydrophobic. Consequently, the proppant of such an embodiment can partially float in the subsurface reservoir and is useful for applications requiring foam coatings.

Further, the polyoxazolidone isocyanurate coating typically exhibits excellent hydrolytic resistance and will not lose strength and durability when exposed to water. Consequently, the proppant can be submerged in the subsurface reservoir and exposed to water and will maintain its strength and durability.

The polyoxazolidone isocyanurate coating can be cured/cross-linked prior to pumping of the proppant into the subsurface reservoir, or the polyoxazolidone isocyanurate coating can be curable/cross-linkable whereby the polyoxazolidone isocyanurate coating cures in the subsurface reservoir due to the conditions inherent therein. These concepts are described further below.

The proppant of the subject invention may comprise the particle encapsulated with a cured polyoxazolidone isocyanurate coating. The cured polyoxazolidone isocyanurate coating typically provides crush strength, or resistance, for the proppant and prevents agglomeration of the proppant. Since the cured polyoxazolidone isocyanurate coating is cured before the proppant is pumped into a subsurface reservoir, the proppant typically does not crush or agglomerate even under high pressure and temperature conditions.

Alternatively, the proppant of the subject invention may comprise the particle encapsulated with a curable polyoxazolidone isocyanurate coating. The curable polyoxazolidone isocyanurate coating typically consolidates and cures subsurface. The curable polyoxazolidone isocyanurate coating is typically not cross-linked, i.e., cured, or is partially cross-linked before the proppant is pumped into the subsurface reservoir. Instead, the curable polyoxazolidone isocyanurate coating typically cures under the high pressure and temperature conditions in the subsurface reservoir. Proppants comprising the particle encapsulated with the curable polyoxazolidone isocyanurate coating are often used for high pressure and temperature conditions.

Additionally, proppants comprising the particle encapsulated with the curable polyoxazolidone isocyanurate coating may be classified as curable proppants, subsurface-curable proppants and partially-curable proppants. Subsurface-curable proppants typically cure entirely in the subsurface reservoir, while partially-curable proppants are typically partially cured before being pumped into the subsurface reservoir. The partially-curable proppants then typically fully cure in the subsurface reservoir. The proppant of the subject invention can be either subsurface-curable or partially-curable.

Multiple layers of the polyoxazolidone isocyanurate coating can be applied to the particle to form the proppant. As such, the proppant of the subject invention can comprise a particle having a cross-linked polyoxazolidone isocyanurate coating disposed on the particle and a curable polyoxazolidone isocyanurate coating disposed on the cross-linked coating, and vice versa. Likewise, multiple layers of the polyoxazolidone isocyanurate coating, each individual layer having the same or different physical properties can be applied to the particle to form the proppant. In addition, the polyoxazolidone isocyanurate coating can be applied to the particle in combination with coatings of different materials such as polyurethane coatings, polycarbodiimide coatings, polyamide imide coatings, and other material coatings.

The polyoxazolidone isocyanurate coating typically exhibits excellent adhesion to inorganic substrates. That is, the isocyanurate and oxizolidone units wets out and bonds with inorganic surfaces, such as the surface of a sand particle, which consists primarily of silicon dioxide. As such, when the particle of the proppant is a sand particle, the polyoxazolidone isocyanurate coating bonds well with the particle to form a proppant which is especially strong and durable.

Nonetheless, and as is alluded to above, the proppant may further include an additive such as a silicon-containing adhesion promoter. The silicon-containing adhesion promoter is also commonly referred to in the art as a coupling agent or as a binder agent. The silicon-containing adhesion promoter binds the polyoxazolidone isocyanurate coating to the particle. More specifically, the silicon-containing adhesion promoter typically has organofunctional silane groups to improve adhesion of the polyoxazolidone isocyanurate coating to the particle. Without being bound by theory, it is thought that the silicon-containing adhesion promoter allows for covalent bonding between the particle and the polyoxazolidone isocyanurate coating. In one embodiment, the surface of the particle is activated with the silicon-containing adhesion promoter by applying the silicon-containing adhesion promoter to the particle prior to coating the particle with the polyoxazolidone isocyanurate coating. In this embodiment, the silicon-containing adhesion promoter can be applied to the particle by a wide variety of application techniques including, but not limited to, spraying, dipping the particles in the polyoxazolidone isocyanurate coating, etc. In another embodiment, the adhesion promoter may be added to a component such as the glycidyl epoxy resin, the isocyanate, and the catalyst. As such, the particle is then simply exposed to the adhesion promoter when the polyoxazolidone isocyanurate coating is applied to the particle. The silicon-containing adhesion promoter is useful for applications requiring excellent adhesion of the polyoxazolidone isocyanurate coating to the particle, for example, in applications where the proppant is subjected to shear forces in an aqueous environment. Use of the silicon-containing adhesion promoter provides adhesion of the polyoxazolidone isocyanurate coating to the particle such that the polyoxazolidone isocyanurate coating will remain adhered to the surface of the particle even if the proppant, including the polyoxazolidone isocyanurate coating, the particle, or both, fractures due to closure stress.

Examples of suitable silicon-containing adhesion promoters include, but are not limited to, glycidoxypropyltrimethoxysilane, aminoethylaminopropyltrimethoxysilane, methacryloxypropyltrimethoxysilane, gamma-aminopropyltriethoxysilane, vinylbenzylaminoethylaminopropyltrimethoxysilane, glycidoxypropylmethyldiethoxysilane, chloropropyltrimethoxysilane, phenyltrimethoxysilane, vinyltriethoxysilane, tetraethoxysilane, methyldimethoxysilane, bis-triethoxysilylpropyldisulfidosilane, bis-triethoxysilylpropyltetrasulfidosilane, phenyltriethoxysilane, aminosilanes, and combinations thereof.

Specific examples of suitable silicon-containing adhesion promoters include, but are not limited to, SILQUEST™ A1100, SILQUEST™ A1110, SILQUEST™ A1120, SILQUEST™ 1130, SILQUEST™ A1170, SILQUEST™ A-189, and SILQUEST™ Y9669, all commercially available from Momentive Performance Materials of Albany, N.Y. A particularly suitable silicon-containing adhesion promoter is SILQUEST™ A1100, i.e., gamma-aminopropyltriethoxysilane. The silicon-containing adhesion promoter may be present in the proppant in an amount of from 0.001 to 10, alternatively from 0.01 to 5, alternatively from 0.02 to 1.25, parts by weight, based on 100 parts by weight of the proppant. The amount silicon-containing adhesion promoter present in the proppant may vary outside of the ranges above, but is typically both whole and fractional values within these ranges.

As is also alluded to above, the proppant may further include an additive such as a wetting agent. The wetting agent is also commonly referred to in the art as a surfactant. The proppant may include more than one wetting agent. The wetting agent may include any suitable wetting agent or mixtures of wetting agents known in the art. The wetting agent is employed to increase a surface area contact between the polyoxazolidone isocyanurate coating and the particle. In a typical embodiment, the wetting agent is added with a component such as the glycidyl epoxy resin, the isocyanate, and/or the catalyst. In another embodiment, the surface of the particle is activated with the wetting agent by applying the wetting agent to the particle prior to coating the particle with the polyoxazolidone isocyanurate coating.

A suitable wetting agent is BYK® 310, a polyester modified poly-dimethyl-siloxane, commercially available from BYK Additives and Instruments of Wallingford, Conn. The wetting agent may be present in the proppant in an amount of from 0.001 to 10, alternatively from 0.002 to 5, alternatively from 0.0002 to 0.0004, parts by weight, based on 100 parts by weight of the proppant. The amount of wetting agent present in the proppant may vary outside of the ranges above, but is typically both whole and fractional values within these ranges.

The polyoxazolidone isocyanurate coating of this invention may also include the active agent already described above in the context of the particle. In other words, the active agent may be included in the polyoxazolidone isocyanurate coating independent of the particle. Once again, suitable active agents include, but are not limited to organic compounds, microorganisms, and catalysts. The polyoxazolidone isocyanurate coating may include other additives, active or otherwise, such as wetting agents, surfactants, and the like.

The proppant of the subject invention exhibits excellent thermal stability for high temperature and pressure applications, e.g. temperatures greater than 200° C., alternatively greater than 300° C., alternatively greater than 400° C., and/or pressures (independent of the temperatures described above) greater than 7,500 psi alternatively greater than 10,000 psi, alternatively greater than 12,500 psi, alternatively greater than 15,000 psi. The proppant of this invention does not suffer from complete failure of the polyoxazolidone isocyanurate coating due to shear or degradation when exposed to such temperatures and pressures.

Further, with the polyoxazolidone isocyanurate coating of this invention, the proppant exhibits excellent crush strength, also commonly referred to as crush resistance. With this crush strength, the polyoxazolidone isocyanurate coating of the proppant is uniform and is substantially free from defects, such as gaps or indentations, which often contribute to premature breakdown and/or failure of the polyoxazolidone isocyanurate coating. In particular, the proppant exhibits a crush strength of 15% or less maximum fines as measured in accordance with American Petroleum Institute (API) RP60 at pressures ranging from 7,500 to 15,000 psi, including at specific stress pressures of 7,500, 10,000, 12,500, and 15,000 psi.

When 20/40 Ottawa sand is utilized as the particle, a preferred crush strength associated with the proppant of this invention is 15% or less, more preferred 13% or less, and most preferred 10% or less maximum fines as measured in accordance with API RP60 by compressing a proppant sample, which weighs 9.4 grams, in a test cylinder (having a diameter of 1.5 inches as specified in API RP60) for 2 minutes at 9,050 psi and 23° C. After compression, percent fines and agglomeration are determined.

The polyoxazolidone isocyanurate coating of this invention may provide a cushioning effect for the proppant and evenly distributes high pressures, e.g. closure stresses, around the proppant. Therefore, the proppant of the subject invention effectively props open fractures and minimizes unwanted impurities in unrefined petroleum fuels in the form of dust particles.

The proppant may have a bulk density of from 0.1 to 3.0, alternatively from 1.0 to 2.0, g/cm³, according to API Recommended Practices RP60 for testing proppants. Further, the proppant may have an apparent density of from 1.0 to 3.0, alternatively from 2.3 to 2.7, g/cm³, according to API Recommended Practices RP60 for testing proppants.

In one embodiment, one skilled in the art can select the density/specific gravity of the proppant according to the specific gravity of the carrier fluid and whether it is desired that the proppant be lightweight or substantially neutrally buoyant in the selected carrier fluid. In this embodiment, the polyoxazolidone isocyanurate coating can exhibit non-wettability which can contribute to flotation of the proppant depending on the selection of the carrier fluid in the wellbore.

Further, the proppant can minimize unpredictable consolidation. That is, the proppant only consolidates, if at all, in a predictable, desired manner according to carrier fluid selection and operating temperatures and pressures. Also, the proppant is typically compatible with low-viscosity carrier fluids having viscosities of less than 3,000 cps at 80° C. and is typically substantially free from mechanical failure and/or chemical degradation when exposed to the carrier fluids and high pressures. As set forth above, the subject invention also provides the method of forming, or preparing, the proppant. For this method, the particle, the glycidyl epoxy resin, the isocyanate, and the catalyst are provided. As with all other components which may be used in the method of the subject invention (e.g. the particle), the glycidyl epoxy resin, the isocyanate, and the catalyst are just as described above with respect to the polyoxazolidone isocyanurate coating. The glycidyl epoxy resin, the isocyanate, and the catalyst are combined and react to form the polyoxazolidone isocyanurate coating and the particle is coated with the polyoxazolidone isocyanurate coating to form the proppant. The polyoxazolidone isocyanurate coating is not required to be formed prior to exposure of the particle to the individual components, i.e., the glycidyl epoxy resin, the isocyanate, and the catalyst.

That is, the glycidyl epoxy resin, the isocyanate, and the catalyst may be combined to form the polyoxazolidone isocyanurate coating simultaneous with the coating of the particle. Alternatively, as is indicated in certain embodiments below, the glycidyl epoxy resin, the isocyanate, and the catalyst may be combined to form the polyoxazolidone isocyanurate coating prior to the coating of the particle.

The step of combining the glycidyl epoxy resin, the isocyanate, and the catalyst is conducted at a first temperature. At the first temperature, the glycidyl epoxy resin and the isocyanate react in the presence of the catalyst to form the polyoxazolidone isocyanurate coating. The first temperature is may be greater than 50, alternatively from 100 to 250, alternatively from 140 to 250, alternatively from 150 to 200, ° C.

The particle is coated with the polyoxazolidone isocyanurate coating to form the proppant. In one embodiment, the particle is pre-treated with the silicon-containing adhesion promoter prior to the step of coating the particle with the polyoxazolidone isocyanurate coating to form the proppant.

The polyoxazolidone isocyanurate coatings applied to the particle to coat the particle. The particle may optionally be heated to a temperature greater than 50° C. prior to or simultaneous with the step of coating the particle with the polyoxazolidone isocyanurate coating. If heated, a preferred temperature range for heating the particle is from 50 to 220° C.

Various techniques can be used to coat the particle with the polyoxazolidone isocyanurate coating. These techniques include, but are not limited to, mixing, pan coating, fluidized-bed coating, co-extrusion, spraying, in-situ formation of the polyoxazolidone isocyanurate coating, and spinning disk encapsulation. The technique for applying the polyoxazolidone isocyanurate coating to the particle is selected according to cost, production efficiencies, and batch size. The proppant can be coated via economical coating processes and does not require multiple coating layers, and therefore minimizes production costs.

In this method, the steps of combining the glycidyl epoxy resin and the isocyanate in the presence of the catalyst and coating the particle with the polyoxazolidone isocyanurate coating to form the proppant may be collectively conducted in 60 minutes or less, alternatively in 30 minutes or less, alternatively in 1 to 20 minutes.

Once coated, the proppant can be heated to a second temperature to further crosslink the polyoxazolidone isocyanurate coating. The further cross-linking optimizes physical properties of the polyoxazolidone isocyanurate coating as well as the performance of the proppant. The second temperature may be greater than 150, alternatively greater than 180, ° C. In one embodiment, the proppant is heated to the second temperature of 190° C. for 60 minutes. In another embodiment, the proppant is heated to the second temperature in the well bore. If the proppant is heated to a second temperature, the step of heating the proppant can be conducted simultaneous to the step of coating the particle with the polyoxazolidone isocyanurate coating or conducted after the step of coating the particle with the polyoxazolidone isocyanurate coating.

In one embodiment, the polyoxazolidone isocyanurate coating is disposed on the particle via mixing in a vessel, e.g. a reactor. In particular, the individual components of the proppant, e.g. the glycidyl epoxy resin, the isocyanate, the catalyst, and the particle, are added to the vessel to form a reaction mixture. The components may be added in equal or unequal weight ratios. The reaction mixture may be agitated at an agitator speed commensurate with the viscosities of the components. Further, the reaction mixture may be heated at a temperature commensurate with the polyoxazolidone isocyanurate coating technology and batch size. It is to be appreciated that the technique of mixing may include adding components to the vessel sequentially or concurrently. Also, the components may be added to the vessel at various time intervals and/or temperatures.

In another embodiment, the polyoxazolidone isocyanurate coating is disposed on the particle via spraying. In particular, individual components of the polyoxazolidone isocyanurate coating are contacted in a spray device to form a coating mixture. The coating mixture is then sprayed onto the particle to form the proppant. Spraying the polyoxazolidone isocyanurate coating onto the particle typically results in a uniform, complete, and defect-free polyoxazolidone isocyanurate coating disposed on the particle. For example, the polyoxazolidone isocyanurate coating is typically even and unbroken. The polyoxazolidone isocyanurate coating also typically has adequate thickness and acceptable integrity, which allows for applications requiring controlled-release of the proppant in the fracture. Spraying also typically results in a thinner and more consistent polyoxazolidone isocyanurate coating disposed on the particle as compared to other techniques, and thus the proppant is coated economically. Spraying the particle even permits a continuous manufacturing process. Spray temperature may be selected by one known in the art according to polyoxazolidone isocyanurate coating technology and ambient humidity conditions. The particle may also be heated to induce cross-linking of the polyoxazolidone isocyanurate coating. Further, one skilled in the art may spray the components of the polyoxazolidone isocyanurate coating at a viscosity commensurate with the viscosity of the components.

In another embodiment, the polyoxazolidone isocyanurate coating is disposed on the particle in-situ, i.e., in a reaction mixture comprising the components of the polyoxazolidone isocyanurate coating and the particle. In this embodiment, the polyoxazolidone isocyanurate coating is formed or partially formed as the polyoxazolidone isocyanurate coating is disposed on the particle. In-situ polyoxazolidone isocyanurate coating formation steps may include the steps of providing each component of the polyoxazolidone isocyanurate coating, providing the particle, combining the components of the polyoxazolidone isocyanurate coating and the particle, and disposing the polyoxazolidone isocyanurate coating on the particle. In-situ formation of the polyoxazolidone isocyanurate coating may allow for reduced production costs by way of fewer processing steps as compared to existing methods for forming a proppant.

The formed proppant may be prepared according to the method as set forth above and stored in an offsite location before being pumped into the subterranean formation and the subsurface reservoir. As such, coating typically occurs offsite from the subterranean formation and subsurface reservoir. However, it is to be appreciated that the proppant may also be prepared just prior to being pumped into the subterranean formation and the subsurface reservoir. In this scenario, the proppant may be prepared with a portable coating apparatus at an onsite location of the subterranean formation and subsurface reservoir.

The proppant is useful for hydraulic fracturing of the subterranean formation to enhance recovery of petroleum and the like. In a typical hydraulic fracturing operation, a hydraulic fracturing composition, i.e., a mixture, comprising the carrier fluid, the proppant, and optionally various other components, is prepared. The carrier fluid is selected according to wellbore conditions and is mixed with the proppant to form the mixture which is the hydraulic fracturing composition. The carrier fluid can be a wide variety of fluids including, but not limited to, kerosene and water. Typically, the carrier fluid is water. Various other components which can be added to the mixture include, but are not limited to, guar, polysaccharides, and other components know to those skilled in the art.

The mixture is pumped into the subsurface reservoir, which may be the wellbore, to cause the subterranean formation to fracture. More specifically, hydraulic pressure is applied to introduce the hydraulic fracturing composition under pressure into the subsurface reservoir to create or enlarge fractures in the subterranean formation. When the hydraulic pressure is released, the proppant holds the fractures open, thereby enhancing the ability of the fractures to extract petroleum fuels or other subsurface fluids from the subsurface reservoir to the wellbore.

For the method of filtering a fluid, the proppant of the subject invention is provided according to the method of forming the proppant as set forth above. In one embodiment, the subsurface fluid can be unrefined petroleum or the like. However, it is to be appreciated that the method of the subject invention may include the filtering of other subsurface fluids not specifically recited herein, for example, air, water, or natural gas.

To filter the subsurface fluid, the fracture in the subsurface reservoir that contains the unrefined petroleum, e.g. unfiltered crude oil, is identified by methods known in the art of oil extraction. Unrefined petroleum is typically procured via a subsurface reservoir, such as a wellbore, and provided as feedstock to refineries for production of refined products such as petroleum gas, naphtha, gasoline, kerosene, gas oil, lubricating oil, heavy gas, and coke. However, crude oil that resides in subsurface reservoirs includes impurities such as sulfur, undesirable metal ions, tar, and high molecular weight hydrocarbons. Such impurities foul refinery equipment and lengthen refinery production cycles, and it is desirable to minimize such impurities to prevent breakdown of refinery equipment, minimize downtime of refinery equipment for maintenance and cleaning, and maximize efficiency of refinery processes. Therefore, filtering is desirable.

For the method of filtering, the hydraulic fracturing composition is pumped into the subsurface reservoir so that the hydraulic fracturing composition contacts the unfiltered crude oil. The hydraulic fracturing composition is typically pumped into the subsurface reservoir at a rate and pressure such that one or more fractures are formed in the subterranean formation. The pressure inside the fracture in the subterranean formation may be greater than 5,000, greater than 7,000, or even greater than 10,000 psi, and the temperature inside the fracture may be greater than 70° F. and can be as high 375° F. depending on the particular subterranean formation and/or subsurface reservoir.

Although not required for filtering, the proppant can be a controlled-release proppant. With a controlled-release proppant, while the hydraulic fracturing composition is inside the fracture, the polyoxazolidone isocyanurate coating of the proppant typically dissolves in a controlled manner due to pressure, temperature, pH change, and/or dissolution in the carrier fluid in a controlled manner or the polyoxazolidone isocyanurate coating is disposed about the particle such that the particle is partially exposed to achieve a controlled-release. Complete dissolution of the polyoxazolidone isocyanurate coating depends on the thickness of the polyoxazolidone isocyanurate coating and the temperature and pressure inside the fracture, but typically occurs within 1 to 4 hours. It is to be understood that the terminology “complete dissolution” generally means that less than 1% of the coating remains disposed on or about the particle. The controlled-release allows a delayed exposure of the particle to crude oil in the fracture. In the embodiment where the particle includes the active agent, such as the microorganism or catalyst, the particle typically has reactive sites that must contact the fluid, e.g. the crude oil, in a controlled manner to filter or otherwise clean the fluid. If implemented, the controlled-release provides a gradual exposure of the reactive sites to the crude oil to protect the active sites from saturation. Similarly, the active agent is typically sensitive to immediate contact with free oxygen. The controlled-release provides the gradual exposure of the active agent to the crude oil to protect the active agent from saturation by free oxygen, especially when the active agent is a microorganism or catalyst.

To filter the fluid, the particle, which is substantially free of the polyoxazolidone isocyanurate coating after the controlled-release, contacts the subsurface fluid, e.g. the crude oil. It is to be understood that the terminology “substantially free” means that complete dissolution of the polyoxazolidone isocyanurate coating has occurred and, as defined above, less than 1% of the polyoxazolidone isocyanurate coating remains disposed on or about the particle. This terminology is commonly used interchangeably with the terminology “complete dissolution” as described above. In an embodiment where an active agent is utilized, upon contact with the fluid, the particle typically filters impurities such as sulfur, unwanted metal ions, tar, and high molecular weight hydrocarbons from the crude oil through biological digestion. As noted above, a combination of sands/sintered ceramic particles and microorganisms/catalysts are particularly useful for filtering crude oil to provide adequate support/propping and also to filter, i.e., to remove impurities. The proppant therefore typically filters crude oil by allowing the delayed exposure of the particle to the crude oil in the fracture.

The filtered crude oil is typically extracted from the subsurface reservoir via the fracture, or fractures, in the subterranean formation through methods known in the art of oil extraction. The filtered crude oil is typically provided to oil refineries as feedstock, and the particle typically remains in the fracture.

Alternatively, in a fracture that is nearing its end-of-life, e.g. a fracture that contains crude oil that cannot be economically extracted by current oil extraction methods, the particle may also be used to extract natural gas as the fluid from the fracture. The particle, particularly where an active agent is utilized, digests hydrocarbons by contacting the reactive sites of the particle and/or of the active agent with the fluid to convert the hydrocarbons in the fluid into propane or methane. The propane or methane is then typically harvested from the fracture in the subsurface reservoir through methods known in the art of natural gas extraction.

The following examples are meant to illustrate the invention and are not to be viewed in any way as limiting to the scope of the invention.

### EXAMPLES

### Examples 1-9

Examples 1-9 are proppants formed according to the subject invention comprising the polyoxazolidone isocyanurate coating disposed on the particle. Examples 1-9 are formed with the components disclosed in Table 1. The amounts in Tables 1 are in grams.

Prior to forming Examples 1-9, the Particle is activated with the Adhesion Promoter. To activate the Particle, a solution comprising the Adhesion Promoter (at the desired concentration relative to the particle) and solvent (5 parts by weight deionized water and 95 parts by weight ethanol) is applied to the Particle and the Particle is dried at a temperature of 60° C. for 30 minutes. Once dried, the Particle is washed with methanol and dried once again, this time at a temperature of 165° C. for as long as it takes to completely dry the activated Particle (having the Adhesion promoter thereon).

The Particle, now activated, is added to a first reaction vessel. The Epoxy, the Catalyst, the Isocyanate, and, if included, the Additive(s) are hand mixed with a spatula in a second reaction vessel to form a reaction mixture. The reaction mixture is added to the first reaction vessel and mixed with the Particle to (1) uniformly coat the surface of, or wet out, the Particle with the reaction mixture and (2) polymerize the Epoxy and the Isocyanate, to form the proppant comprising the Particle and the polyoxazolidone isocyanurate coating formed thereon. The proppants of Examples 1-9 are heated in an oven, i.e., post-cured, at 150° C. for three hours to further crosslink the polyoxazolidone isocyanurate coating. Examples 1-9 are tested for crush strength, the test results are also set forth in Table 1 below. The appropriate formula for determining percent fines is set forth in API RP60. The crush strength of Examples 1-9 is tested by compressing a proppant sample, which weighs 9.4 grams, in a test cylinder (having a diameter of 3.8 cm (1.5 in) as specified in API RP60) for 2 minutes at 62.4 MPa (9050 psi) and 23° C. After compression, percent fines and agglomeration are determined Agglomeration is an objective observation of a proppant sample, i.e., a particular Example, after crush strength testing as described above. The proppant sample is assigned a numerical ranking between 1 and 10. If the proppant sample agglomerates completely, it is ranked 10. If the proppant sample does not agglomerate, i.e., it falls out of the cylinder after crush test, it is rated 1.

TABLE 1

| | | | | | | | | |
|---|---|---|---|---|---|---|---|---|
| Ex. 1 | Ex. 2 | Ex. 3 | Ex. 4 | Ex. 5 | Ex. 6 | Ex. 7 | Ex. 8 | Ex. 9 |

Polymer Coating

| | | | | | | | | | |
|---|---|---|---|---|---|---|---|---|---|
| Epoxy | 6.50 | 2.78 | 2.78 | 12.00 | 12.00 | 12.00 | 14.00 | 14.00 | 16.00 |
| Isocyanate A | 2.78 | 6.50 | 6.50 | 28.00 | 28.00 | 28.00 | 26.00 | 26.00 | 24.00 |
| Catalyst A | 0.10 | 0.04 | 0.04 | 0.15 | 0.12 | 0.09 | 0.21 | 0.18 | 0.24 |

Proppant

| | | | | | | | | | |
|---|---|---|---|---|---|---|---|---|---|
| Particle | 300.0 | 300.0 | 300.0 | 250.0 | 250.0 | 250.0 | 250.0 | 250.0 | 250.0 |
| Coating | 9.3 | 9.3 | 9.3 | 7.7 | 7.7 | 7.7 | 7.7 | 7.7 | 7.7 |

Processing Parameters

| | | | | | | | | | |
|---|---|---|---|---|---|---|---|---|---|
| Starting Sand | 23 | 23 | 150 | 23 | 23 | 23 | 23 | 23 | 23 |
| Temp. (° C.) | | | | | | | | | |
| Coating Mix | 1 | 1 | 1 | 1 | 1 | 1 | 1 | 1 | 1 |
| (min/° C.) | 23 | 23 | 23 | 23 | 23 | 23 | 23 | 23 | 23 |
| Proppant Mix | 1 | 1 | 9:45 | 10 | 10 | 10 | 10 | 10 | 10 |
| (min/° C.) | 12 | 23 | 131 | 140 | 140 | 140 | 140 | 140 | 140 |
| Mixture Method | Hand | Hand | Jiffy | Jiffy | Jiffy | Jiffy | Jiffy | Jiffy | Jiffy |
| | Mix | Mix | Mixer | Mixer | Mixer | Mixer | Mixer | Mixer | Mixer |
| | Spatula | Spatula | 640 Rpm | 640 rpm | 640 rpm | 640 rpm | 640 rpm | 640 rpm | 640 rpm |
| Post Cure (hr/° C.) | 3/150 | 3/150 | 3/150 | 3/150 | 3/150 | 3/150 | 3/150 | 3/150 | 3/150 |

Physical Properties

| | | | | | | | | | |
|---|---|---|---|---|---|---|---|---|---|
| Crush Strength (% | 17.0 | 11.3 | 13.1 | 11.6 | 11.4 | 13.7 | 12.6 | 11.7 | 13.3 |
| Fines <0.425 mm | | | | | | | | | |
| (sieve size 40)) | | | | | | | | | |
| Agglomeration | 4 | 2 | — | 2 | 3 | 4 | 3 | 3 | 3 |
| (1-10) | | | | | | | | | |

Epoxy is bisphenol A diglycidyl ether (BADGE).

Isocyanate A is polymeric diphenylmethane diisocyanate having an NCO content of 31.4 weight percent, a nominal functionality of 2.7, and a viscosity at 77° F. of 200 cps.

Catalyst A is N-methylimidazole(1-methylimidazole).

Particle is Ottawa sand having a sieve size of 0.850/0.425 mm (20/40 U.S. Sieve No.) which is pretreated with 400 ppm by weight gamma-aminopropyltriethoxysilane.

Referring now to Table 1, the proppants of Examples 1-9 demonstrate excellent crush strength and agglomeration while comprising just 3.0 parts by weight polyoxazolidone isocyanurate coating, based on 100 parts by weight of the proppant.

### Examples 10-30

Examples 10-30 are polyoxazolidone isocyanurate coatings according to the subject invention. Examples 10-30 are formed with the components disclosed in Tables 2-4. The amounts in Tables 2-4 are in grams.

Prior to forming Examples 10-30, the Epoxy, the Catalyst, the Isocyanate, and, if included, the Additive(s) are hand mixed with a spatula in a second reaction vessel to form a reaction mixture. The reaction mixture is added to the first reaction vessel and mixed. The polyoxazolidone isocyanurate coatings of Examples 10-30 are heated in an oven, i.e., post-cured, at 150° C. for three hours.

Examples 10-30 are tested for color, hardness, and cell formation, the test results are also set forth in Tables 2-4 below. Generally, these tests are conducted gage the durability of the respective polyoxazolidone isocyanurate coatings.

TABLE 2

| | | | | | | |
|---|---|---|---|---|---|---|
| Ex. 10 | Ex. 11 | Ex. 12 | Ex. 13 | Ex. 14 | Ex. 15 | Ex. 16 |

Polymer Coating

| | | | | | | | |
|---|---|---|---|---|---|---|---|
| Epoxy | 8.00 | 12.00 | 12.00 | 4.00 | 4.00 | 8.00 | 4.00 |
| Isocyanate A | 12.00 | 8.00 | 8.00 | 16.00 | 16.00 | 12.00 | 16.00 |
| Catalyst A | 0.04 | 0.12 | — | — | 0.04 | 0.12 | — |
| Catalyst B | — | — | 0.06 | 0.06 | — | 0.00 | 0.02 |

Processing Parameters

| | | | | | | | |
|---|---|---|---|---|---|---|---|
| Initial Particle | 23 | 23 | 23 | 123 | 23 | 23 | 23 |
| Temp. (° C.) | 123 | 123 | 123 | | | | |
| Coating Mix | 1 | 1 | 1 | 1 | 1 | 1 | 1 |
| (min/° C.) | 23 | 23 | 23 | 23 | 23 | 23 | 23 |
| Proppant Mix | 10 | 10 | 10 | 10 | 10 | 10 | 10 |
| (min/° C.) | 140 | 140 | 140 | 140 | 140 | 140 | 140 |
| Mixture Method | Jiffy | Jiffy | Jiffy | Jiffy | Jiffy | Jiffy | Jiffy |
| | Mixer | Mixer | Mixer | Mixer | Mixer | Mixer | Mixer |
| | 640 rpm | 640 rpm | 640 rpm | 640 Rpm | 640 rpm | 640 Rpm | 640 rpm |
| Post Cure (hr./° C.) | 3/150 | 3/150 | 3/150 | 3/150 | 3/150 | 3/150 | 3/150 |

Physical Properties

| | | | | | | | |
|---|---|---|---|---|---|---|---|
| Color (Gardner) | 17 | >18 | 13 | 11 hazy | >18 | >18 brown | 12 hazy |
| Hardness (SD) | 75.7 | 75.1 | 84.5 | 76.5 | — | 77.2 | 82.5 |
| Cell Formation | Yes | Yes | No | No | Yes | Yes | No |

TABLE 3

| | | | | | | |
|---|---|---|---|---|---|---|
| Ex. 17 | Ex. 18 | Ex. 19 | Ex. 20 | Ex. 21 | Ex. 22 | Ex. 23 |

Polymer Coating

| | | | | | | | |
|---|---|---|---|---|---|---|---|
| Epoxy | 8.00 | 12.00 | 12.00 | 4.00 | 6.00 | 6.00 | 6.00 |
| Isocyanate A | 12.00 | 8.00 | 8.00 | 16.00 | 7.00 | 7.00 | 9.10 |
| Isocyanate B | — | — | — | — | 7.00 | 7.00 | 4.90 |
| Catalyst B | 0.08 | 0.18 | 0.06 | 0.06 | 0.06 | 0.06 | 0.06 |

Processing Parameters

| | | | | | | | |
|---|---|---|---|---|---|---|---|
| Initial Particle | 23 | 23 | 23 | 23 | 23 | 23 | 23 |
| Temp. (° C.) | | | | | | | |
| Coating Mix | 1 | 1 | 1 | 1 | 1 | 1 | 1 |
| (min/° C.) | 23 | 23 | 23 | 23 | 23 | 23 | 23 |
| Proppant Mix | 10 | 10 | 10 | 10 | 10 | 10 | 10 |
| (min/° C.) | 140 | 140 | 140 | 140 | 140 | 140 | 140 |
| Mixture Method | Jiffy | Jiffy | Jiffy | Jiffy | Jiffy | Jiffy | Jiffy |
| | Mixer | Mixer | Mixer | Mixer | Mixer | Mixer | Mixer |
| | 640 rpm | 640 rpm | 640 rpm | 640 rpm | 640 rpm | 640 rpm | 640 rpm |
| Post Cure (hr./° C.) | 3/150 | 3/150 | 3/150 | 3/150 | 3/150 | 3/150 | 3/150 |

Physical Properties

| | | | | | | | |
|---|---|---|---|---|---|---|---|
| Color (Gardner) | 12 hazy | 13 hazy | 15 hazy | 16 | 13 cloudy | 12 cloudy | 12 |
| Hardness (SD) | 85.8 | 80.4 | 85.0 | 86.5 | 90.6 | 88.3 | 84.5 |
| Cell Formation | No | No | No | No | No | No | Yes |

TABLE 4

| | | | | | | |
|---|---|---|---|---|---|---|
| Ex. 24 | Ex. 25 | Ex. 26 | Ex. 27 | Ex. 28 | Ex. 29 | Ex. 30 |

Polymer Coating

| | | | | | | | |
|---|---|---|---|---|---|---|---|
| Epoxy | 6.00 | 5.00 | 5.00 | 5.00 | 5.00 | 4.00 | 5.00 |
| Isocyanate A | — | 11.67 | 11.67 | 11.67 | 11.67 | 11.67 | 11.67 |
| Isocyanate B | 14.00 | — | — | — | — | — | — |
| Catalyst B | 0.09 | 0.07 | 0.07 | 0.07 | 0.07 | 0.07 | 0.07 |
| Additive A | — | 0.04 | 0.04 | 0.04 | 0.04 | 0.04 | 0.04 |
| Additive B | — | 0.27 | — | — | — | — | — |
| Additive C | — | — | 0.27 | — | — | — | — |
| Additive D | — | — | — | 1.03 | — | — | — |
| Additive E | — | — | — | — | 1.95 | — | — |
| Additive F | — | — | — | — | — | 1.00 | — |
| Additive G | — | — | — | — | — | — | 0.97 |

Processing Parameters

| | | | | | | | |
|---|---|---|---|---|---|---|---|
| Starting Temp. | 23 | 23 | 23 | 23 | 23 | 23 | 23 |
| (° C.) | | | | | | | |
| Coating Mix | 1 | 1 | 1 | 1 | 1 | 1 | 1 |
| (min/° C.) | 23 | 23 | 23 | 23 | 23 | 23 | 23 |
| Proppant Mix | 10 | 10 | 10 | 10 | 10 | 10 | 10 |
| (min/° C.) | 140 | 140 | 140 | 140 | 140 | 140 | 140 |
| Mixture Method | Jiffy | Jiffy | Jiffy | Jiffy | Jiffy | Jiffy | Jiffy |
| | Mixer | Mixer | Mixer | Mixer | Mixer | Mixer | Mixer |
| | 640 rpm | 640 rpm | 640 rpm | 640 rpm | 640 rpm | 640 rpm | 640 rpm |
| Post Cure (hr./° C.) | 3/150 | 3/150 | 3/150 | 3/150 | 3/150 | 3/150 | 3/150 |

Physical Properties

| | | | | | | | |
|---|---|---|---|---|---|---|---|
| Color (Gardner) | 18 | 13 hazy | 13 hazy | 13 hazy | 13 hazy | 13 hazy | — |
| Hardness (SD) | 82.6 | 87 | 86 | 85.5 | 87.6 | 86 | — |
| Cell Formation | Yes | No | No | No | No | No | No |

Isocyanate B is 4,4′-methylenediphenyl diisocyanate having an NCO content of 33.5 weight percent and a nominal functionality of 2.0, which is solid at 77° F.

Catalyst B is N,N-dimethylcyclohexylamine (DMCHA).

Additive A is a silicone antifoaming agent.

Additive B is 1,4-butanediol.

Additive C is a 2-functional diamine having weight average molecular weight of 310 g/mol, an equivalent weight of 155, and an OH number of 362 mg KOH/g.

Additive D is trimethyl pentanyl diisobutyrate ([2,2,4-trimethyl-3-(2-methylpropanoyloxy)pentyl]2-methylpropanoate).

Additive E is Arizona sand having a particle size of 70 mesh (US Sieve No.).

Additive F is epoxidized soybean oil having a weight average molecular weight of 1000 g/mol.

Additive G is a trifunctional primary amine having a weight average molecular weight of 5000 g/mol.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

1. A proppant for hydraulically fracturing a subterranean formation, said proppant comprising:
A. a particle; and
B. a polyoxazolidone isocyanurate coating disposed about said particle and comprising the reaction product of;
(i) a glycidyl epoxy resin, and
(ii) an isocyanate,
in the presence of a catalyst.

2. A proppant as set forth in claim 1 wherein said glycidyl epoxy resin is further defined as a glycidyl ether epoxy resin.

3. A proppant as set forth in claim 2 wherein said glycidyl ether epoxy resin is further defined as a bisphenol A diglycidyl ether.

4. A proppant as set forth in claim 3 wherein said bisphenol A diglycidyl ether is reacted, to form said polyoxazolidone isocyanurate coating, in an amount of from 0.1 to 8 parts by weight based on 100 parts by weight of said proppant.

5. A proppant as set forth in claim 1 wherein said catalyst is an amine catalyst and/or a phosphine catalyst.

6. A proppant as set forth in claim 1 wherein said catalyst comprises an azole.

7. A proppant as set forth in claim 1 wherein said isocyanate is reacted, to form said polyoxazolidone isocyanurate coating, in an amount of from 0.3 to 17 parts by weight based on 100 parts by weight of said proppant.

8. A proppant as set forth in claim 1 wherein said particle is selected from the group of minerals, ceramics, sands, nut shells, gravels, mine tailings, coal ashes, rocks, smelter slag, diatomaceous earth, crushed charcoals, micas, sawdust, wood chips, resinous particles, polymeric particles, and combinations thereof.

9. A proppant as set forth in claim 1 wherein said polyoxazolidone isocyanurate coating is present in an amount of from 0.5 to 30 parts by weight based on 100 parts by weight of said proppant.

10. A proppant as set forth in claim 1 wherein said polyoxazolidone isocyanurate coating has a T_{g} of greater than 200° C.

11. A proppant as set forth in claim 1 wherein said polyoxazolidone isocyanurate coating comprises greater than 10% by weight oxazolidone units and/or greater than 40% by weight isocyanurate units.

12. A proppant as set forth in claim 1 having a crush strength of 15% or less maximum fines less than 0.425 mm (sieve size 40) as measured by compressing a 9.4 g sample of said proppant in a test cylinder having a diameter of 3.8 cm (1.5 in) for 2 minutes at 62.4 MPa (9050 psi) and 23° C.

13. A method of hydraulically fracturing a subterranean formation which defines a subsurface reservoir with a mixture comprising a carrier fluid and the proppant as set forth in claim 1.

14. A method of forming a proppant for hydraulically fracturing a subterranean formation, wherein the proppant comprises a particle and a polyoxazolidone isocyanurate coating disposed about the particle, and the polyoxazolidone isocyanurate coating comprises the reaction product of a glycidyl epoxy resin and an isocyanate in the presence of a catalyst, said method comprising the steps of:
A. combining the glycidyl epoxy resin and the isocyanate in the presence of the catalyst to react and form the polyoxazolidone isocyanurate coating; and
B. coating the particle with the polyoxazolidone isocyanurate coating to form the proppant.

15. A method as set forth in claim 14 wherein the step of combining is further defined as combining the glycidyl epoxy resin, the isocyanate, and the catalyst at a first temperature of greater than 50° C.

16. A method as set forth in claim 15 further comprising the step of heating the proppant to a second temperature greater than 150° C. after the step of coating the particle with the polyoxazolidone isocyanurate coating.

17. A method as set forth in claim 14 wherein the step of combining the glycidyl epoxy resin and the isocyanate in the presence of the catalyst to react and form the polyoxazolidone isocyanurate coating is conducted simultaneous with the step of coating the particle with the polyoxazolidone isocyanurate coating to form the proppant, and wherein the steps are conducted in 60 minutes or less.

18. A method as set forth in claim 14 wherein the glycidyl epoxy resin is a bisphenol A diglycidyl ether and the catalyst is an azole.

19. A method as set forth in claim 14 wherein the glycidyl epoxy resin is reacted in an amount of from 0.1 to 8 parts by weight based on 100 parts by weight of the proppant, and the isocyanate is reacted in an amount of from 0.3 to 17 parts by weight based on 100 parts by weight of the proppant to form the polyoxazolidone isocyanurate coating.

20. A method as set forth in claim 14 wherein the polyoxazolidone isocyanurate coating comprises greater than 10% by weight oxazolidone units and/or greater than 40% by weight isocyanurate units.
